(19) United States
(12) Patent Application Publication
(10) Pub. No.: US 2025/0223208 A1
(43) Pub. Date: Jul. 10, 2025

(54) DEVICE FOR CLEANING A HONEYCOMB CERAMIC FOR THE TREATMENT OF LIQUID ECONOMIC MANURES AND CORRESPONDING METHOD

(71) Applicant: WK Filtertechnik UG & Co. KG, Schiffdorf (DE)

(72) Inventor: Steven KRUG, Schiffdorf (DE)

(73) Assignee: WK Filtertechnik UG & Co. KG, Schiffdorf (DE)

(21) Appl. No.: 18/846,810

(22) PCT Filed: Jan. 17, 2023
(86) PCT No.: PCT/EP2023/050977

§ 371 Date: Sep. 13, 2024

(30) Foreign Application Priority Data
Mar. 16, 2022 (EP) 22162471.1

(51) Int. Cl. C02F 3/04; C02F 3/10; C02F 3/30; C02F 103/20

(52) U.S. Cl. CPC C02F 3/04; C02F 3/101; C02F 3/301; C02F 2103/20; C02F 2303/16

(57) ABSTRACT

The invention relates to a device for cleaning a honeycomb ceramic for the treatment of liquid economic manures; with a honeycomb ceramic for filtering contaminated water, such as fermentation residues, wherein the honeycomb ceramic has an inlet side for introducing the contaminated water and an outlet side for discharging the water filtered in the honeycomb ceramic and the substances separated from the contaminated water, wherein microorganisms for the cleavage of the contaminated water are provided in the honeycomb ceramic, and wherein the honeycomb ceramic has a plurality of channels running between the inlet side and the outlet side; and with a cleaning device arranged at the inlet side or the outlet side of the honeycomb ceramic, which is set up for cleaning the plurality of channels of the honeycomb ceramic. The invention furthermore relates to a method for cleaning a honeycomb ceramic for processing liquid economic manures from agriculture.

Device for cleaning a honeycomb ceramic for the treatment of liquid economic manures and corresponding method

The invention relates to a device for cleaning a honeycomb ceramic for the treatment of liquid economic manures.

It is known from the prior art to evaporate the water contained therein for the filtration of liquid economic manures by heating fermentation residues, which however leads to considerable energy costs due to the high process heat required and ultimately cannot be operated economically.

Furthermore, it is known to try to separate the water from the solids with the use of filters or membranes. Finally, the water must be passed through ever smaller pores so that the nutrients present in the water remain in the filter. However, this method results in high costs for the mechanics, the cleaning and energy. This method is also known under the name reverse osmosis.

A conventional method furthermore consists in the transfer of fermentation residues to foreign fields with trucks, in some cases also over long distances and to other locations. This is associated with high costs of more than 20 euros per cubic meter, depending on the destination. This disposal is only to be considered as the very last alternative for the farmer if he has no other chance of being able to dispose of the fermentation residues in surrounding fields. The aforementioned methods for the filtration or disposal of fermentation residues are not competitive in terms of price and are at least 15 euros per cubic meter, which arise during the disposal.

Furthermore, so-called central plants are known, which are based on a mechanical, biological, thermal and chemical process sequence for the reprocessing of the economic manure. However, even in the case of these, the manure must continue to be brought to the central collection point. Furthermore, such plants require a personnel outlay of at least 7 employees, which causes considerable permanent operating costs.

In summary, the methods discussed above thus have the following disadvantages: The method of drying or of the vacuum evaporator is very energy-intensive. The filtration via a membrane by reverse osmosis is very prone to repair or is maintenance-intensive. The transfer of fermentation residues to foreign fields with trucks is extremely expensive per transport. The use of a central plant entails high personnel and operating costs.

There is a need for operators of biogas plants and farms with larger animal stocks for a solution for the efficient and sustainable handling of economic manures.

It is therefore the object of the invention to improve a device for the filtration of liquid economic manures in such a way that it can be operated in a favorable, energy-efficient and low-maintenance manner.

The object is achieved with the features of the independent claims.

Accordingly, it is provided that the device has a honeycomb ceramic for filtering contaminated water, such as fermentation residues, wherein the honeycomb ceramic has an inlet side for introducing the contaminated water and an outlet side for discharging the water filtered in the honeycomb ceramic and the substances separated from the contaminated water, wherein microorganisms for the cleavage of the contaminated water are provided in the honeycomb ceramic, and wherein the honeycomb ceramic has a plurality of channels running between the inlet side and the outlet side. Furthermore, the device has a cleaning device arranged at the inlet side or the outlet side of the honeycomb ceramic, which is set up for cleaning the plurality of channels of the honeycomb ceramic.

As a result of the microbacterial treatment, the device according to the invention has the advantage of realizing a significantly more efficient method compared to the known methods with mechanical, thermal or chemical clarification. As a result, an economical operation of biogas plants is made possible and at the same time an effective method for the preservation of clean groundwater is provided. As a result of the lower energy consumption, fewer CO₂ emissions are generated. Furthermore, the device makes possible a reduction of the traffic volume, as a result of the transport of the fermentation residues by truck which is then no longer necessary. In addition, the device makes possible a permanent operation and therefore contributes a part to the indispensable preservation of the energy base load protection. It can be provided that, in an aerobic nitrification stage, a first type of microorganisms is set up for converting ammonium and nitrite into nitrate. Furthermore, a second type of microorganisms can be provided, which is set up in an anaerobic denitrification stage to reduce the nitrate content.

In the plant, no chemistry is used, but microorganisms. These microorganisms are configured specifically for the cleavage of the waste water. The habitat of the microorganisms is represented by the ceramic blocks or the honeycomb ceramic, a natural material which, in addition to excellent conditions, offers a very large settlement area for the microorganisms. With an intended size of the device, it fits into two 40-foot containers and offers the microorganisms a settlement area of approximately 136 ha.

It can be provided that the device is used in a closed circuit. For example, the device can be accommodated in a container. In this case, contaminated water or fermentation residues (ammonium, nitrate, nitrite and phosphorus) can be introduced on one side of the container. After flowing through the honeycomb ceramic, approximately 90% of introducible water and solids with fertilizer (nitrogen and phosphorus) can come out on the other side. The honeycomb ceramic can be designed as a substantially cubic ceramic block, wherein the microorganisms can be native in the honeycomb ceramic. The honeycomb ceramic is thus ideally suitable for achieving maximum filtering and decomposition of the nutrients in the smallest space.

The cleaning device is set up so that the plant can be operated without interruption. For this purpose, it can be provided that the cleaning device in each case covers only a part of the honeycomb ceramic and is moved back and forth over the surface, i.e. the inlet side or outlet side of the honeycomb ceramic, during operation, so that the water to be cleaned can still flow through the uncovered channels of the honeycomb ceramic in each case. It can be provided that the cleaning device is set up for counterflushing and/or cleaning the colonization medium. For this purpose, it can be provided that the cleaning device flushes through or sprays through the channels of the honeycomb ceramic with a high water pressure.

As a result, it is possible that the plant can operate largely independently of temperature and autonomously at a process heat of approximately 35 degrees and that 24 hours a day and 365 days a year. The microorganisms are largely resistant to interruptions. This is because even if they starve as a result of stopping the supply of the “food” (fermentation residues), it can be provided that enough of them survive in order to recover to old degradation strength within a very short time at a doubling rate within 24 hours. The intended doubling rate of the microorganisms can therefore be 24 hours. A plant can also be restarted at any time by the addition of new microorganisms, for example, if these are kept constantly in a microorganism bank. In order to prevent the transfer from the plant into the clarified water, it can be provided that the microbes remaining after passing the honeycomb ceramic are rendered harmless in the last stage with UV lamps.

It can be provided that the channels running between the inlet side and the outlet side have a diameter of in each case at least 2 mm, preferably at least 3 mm. By selecting this preferred region, on the one hand a large surface for the colonization of microorganisms can be provided, on the other hand a good cleaning of the channels by the cleaning device is made possible. This preferred region represents an optimal compromise between the two properties.

Furthermore, the cleaning device can have at least one nozzle directed in the direction of the honeycomb ceramic for discharging a cleaning liquid, by means of which the plurality of channels can be flushed through. The nozzle has the function of blowing out the dirt particles collected in the ceramic blocks. These can collect in particular on the inner walls of the channels and gradually block them.

wherein the nozzle has sealing means for laterally sealing the nozzle, wherein the sealing means bear against the inlet side or the outlet side of the honeycomb ceramic. The nozzle can be arranged here in such a way that it is movable directly on the honeycomb ceramic with the sealing means. The sealing means can be embodied as silicone seals. By providing the sealing means, the water jet or the cleaning agent jet can be guided into the channels in a targeted manner without the cleaning agent being able to escape orthogonally to the channels.

Furthermore, it can be provided that the nozzle is set up for simultaneously cleaning at least two of the plurality of channels. The two or more of the plurality of simultaneously cleaned channels can be arranged next to one another here.

Furthermore, it can be provided that the cleaning device has a drive, by means of which the nozzle is movable along the inlet side or the outlet side of the honeycomb ceramic. In particular, it can be provided that the cleaning device can be moved linearly. For this purpose, the cleaning device can have a drive, which is set up for linearly moving the cleaning device. On the side facing away from the honeycomb ceramic, the cleaning device can have one or more inlets for supplying the nozzle with cleaning agent and air pressure. Corresponding supply lines, in particular a water line and an air pressure line, can be connected to the inlets.

Furthermore, it can be provided that the nozzle is fixed laterally in at least one rail and is movable along the latter. Alternatively, the cleaning device can have a frame or a frame, in which the nozzle is held, wherein the cleaning device runs over the frame or the frame in the rail. In particular, the cleaning device or the nozzle can have two rails on opposite sides, in particular orthogonally to the movement axis. Furthermore, the cleaning device or the nozzle can have means for moving the cleaning device or the nozzle in the rails, in particular rollers. Alternatively, it can be provided that at least one of the rails is designed as a threaded spindle and the nozzle has a corresponding thread, so that the nozzle can be driven by means of the threaded spindle.

Furthermore, it can be provided that the honeycomb ceramic extends in a longitudinal and in a transverse direction, along which the plurality of channels are arranged in longitudinal and transverse rows in a grid-like manner, wherein the nozzle extends along at least one longitudinal row and is movable in the transverse direction or vice versa. Thus, it can be provided in particular that the honeycomb ceramic has a rectangular or square cross section. In particular, it can be provided that the nozzle extends along a complete longitudinal or transverse row and is set up for cleaning all channels present in this row.

Furthermore, it can be provided that the cleaning device is set up for discharging the cleaning liquid at a pressure of 1 bar. The device can furthermore have a sensor system, by means of which it can be determined whether the current water pressure is sufficient to remove the dirt present. If it is determined that the pressure is sufficient, the current pressure can be maintained. If it is determined that the pressure is not sufficient, the pressure can be correspondingly readjusted, in particular increased, up to a point at which the sensor system detects a successful removal of the dirt.

Furthermore, it can be provided that the cleaning device is connected to a pump and a compressor for conveying the cleaning liquid. In this case, it can be provided that the pump pumps the cleaning liquid up to the nozzle and that the nozzle furthermore has a plurality of inlets, distributed over the nozzle, for the compressed air, by means of which the exit speed of the water from the nozzle can be increased. For this purpose, it can furthermore be provided that the nozzle tapers towards the outlet.

The invention furthermore relates to a method for cleaning a honeycomb ceramic for processing liquid economic manures from agriculture by means of a device according to one of claims 1 to 10, having the steps:
subjecting the inlet side of the honeycomb ceramic to contaminated water, such as fermentation residues;
discharging the water filtered in the honeycomb ceramic and the substances separated from the contaminated water from the outlet side of the honeycomb ceramic;
cleaning the plurality of channels of the honeycomb ceramic by means of the cleaning device, wherein a cleaning liquid is discharged in the direction of the channels for cleaning the channels by means of the cleaning device.

The method of operation of the device or the sequence of the method is carried out in this case as follows: The separated fermentation residues come from the biogas plant and are finely filtered again in order then to be fed to an aerobic nitrification stage. Here, ammonium and nitrite are converted into nitrate. This is carried out by means of a first type of microorganisms which are accommodated in the honeycomb ceramic. In an anaerobic denitrification stage, other microorganisms then reduce the nitrate content. Further nutrient stages which are collected are excreted. Since the microorganisms die after a few days after they have increased exponentially, they accommodate almost all the nutrients which are filtered off, only phosphorus is separated out. The greatest challenge consists in cleaning the ceramic block. This is ensured by the nozzle according to the invention, so that the plant can be operated without interruption.

It can be provided that the subjecting of the honeycomb ceramic to contaminated water is not interrupted during the cleaning. This is made possible in particular by the fact that the cleaning device in each case continuously cleans only a partial number of the channels at the same time or is moved over the honeycomb ceramic block at specific time intervals.

It can thus be provided that the cleaning device successively cleans the channels, wherein the cleaning device in each case simultaneously cleans at least two channels.

Furthermore, it can be provided that the cleaning device is moved along the inlet side or the outlet side of the honeycomb ceramic by means of a drive.

For cleaning the channels of the honeycomb ceramic, it can be provided that the cleaning liquid is an air-water mixture and is discharged at a pressure of 1 bar.

Exemplary embodiments of the invention will be explained with reference to the following figures. In the figures:

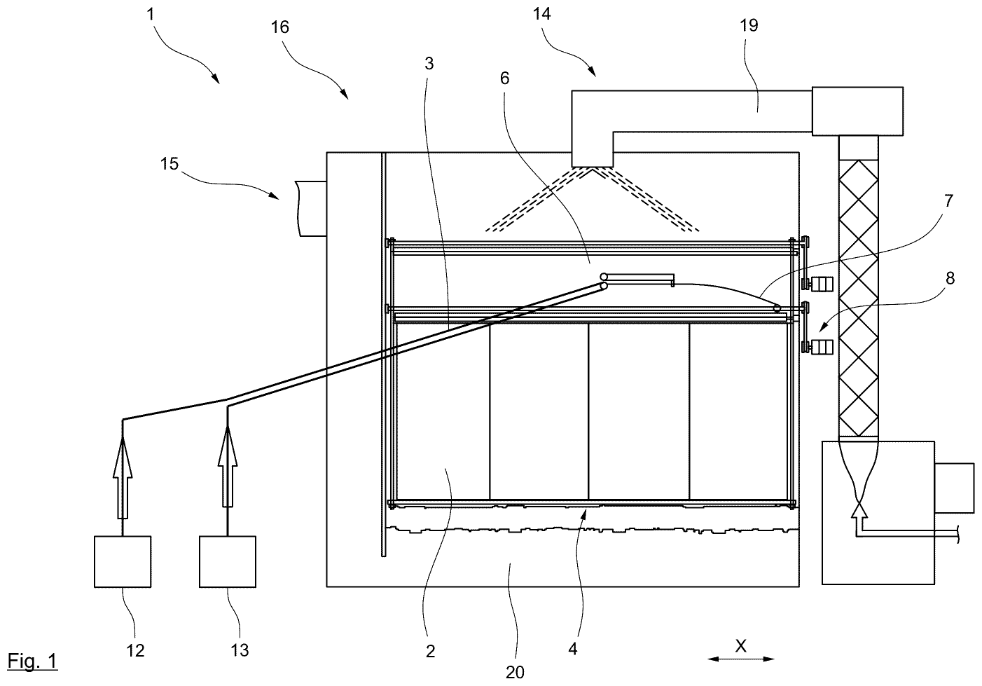

FIG. 1 shows a side view of an embodiment of the device according to the invention;

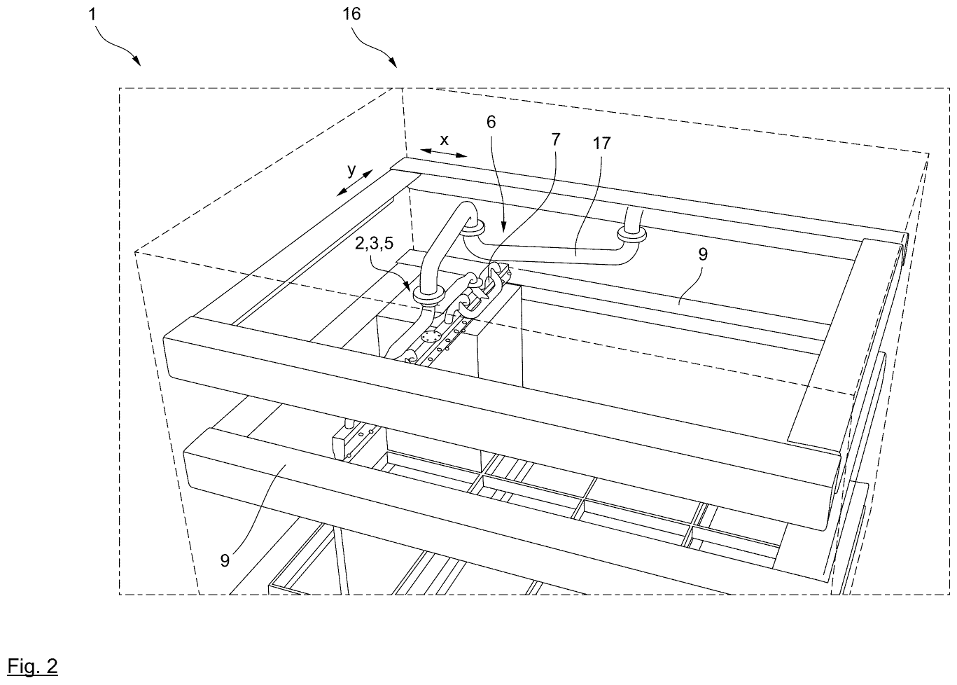

FIG. 2 shows a perspective view of an embodiment of the device according to the invention;

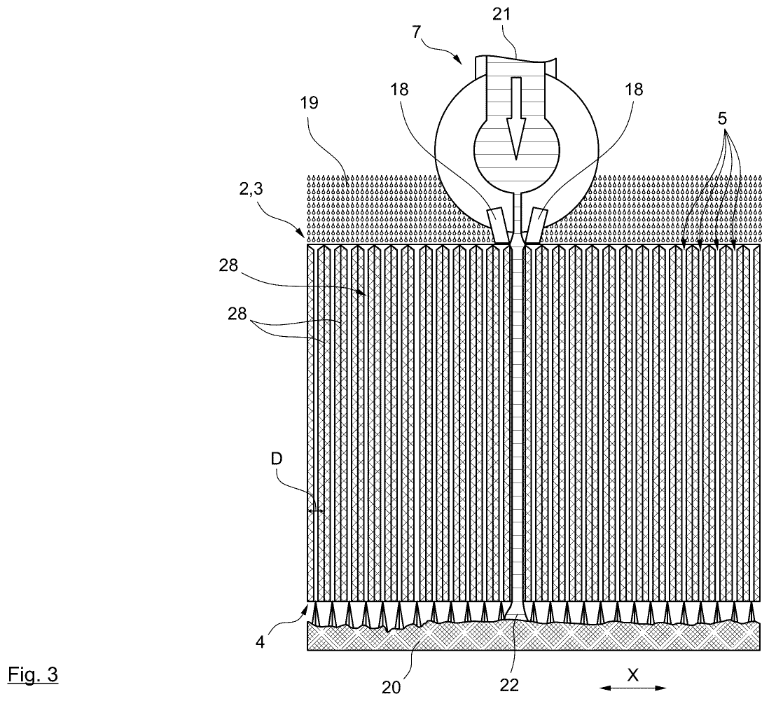

FIG. 3 shows a cross-sectional view of an embodiment of the honeycomb ceramic;

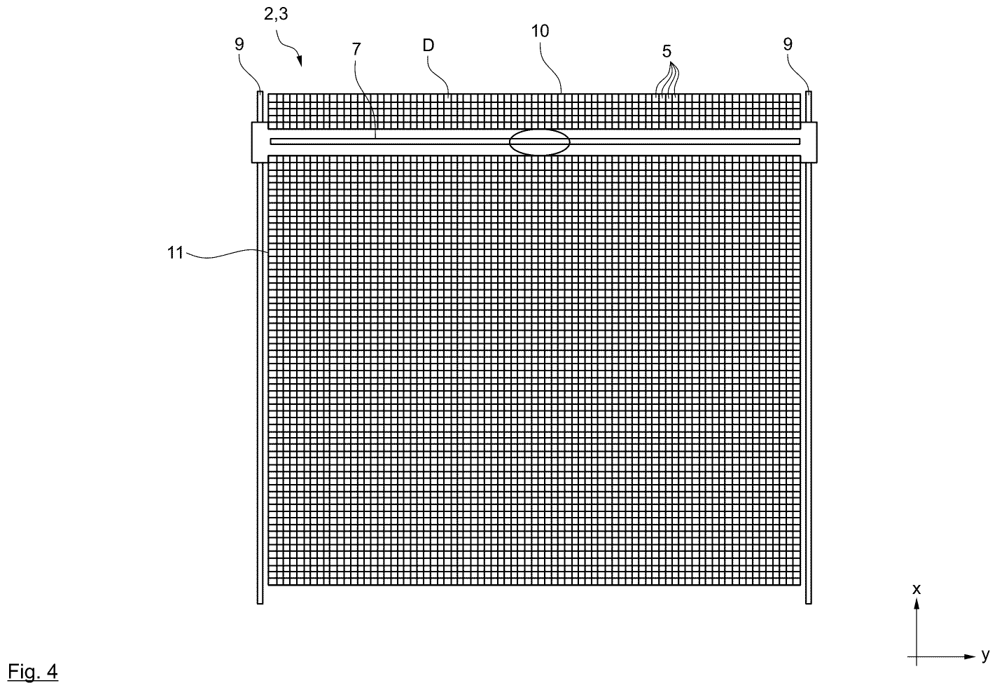

FIG. 4 shows a plan view of an embodiment of the honeycomb ceramic;

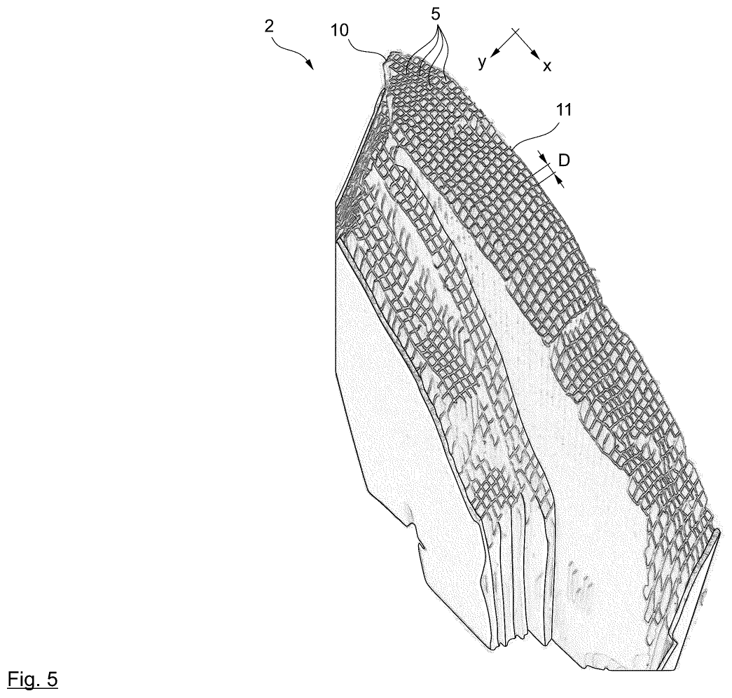

FIG. 5 shows an inner view of an embodiment of the honeycomb ceramic;

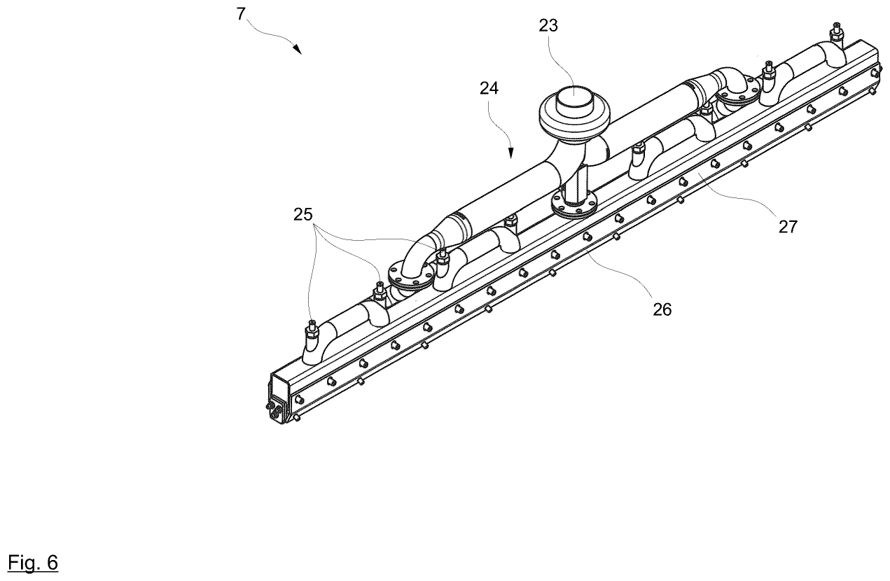

FIG. 6 shows a perspective view of an embodiment of the nozzle;

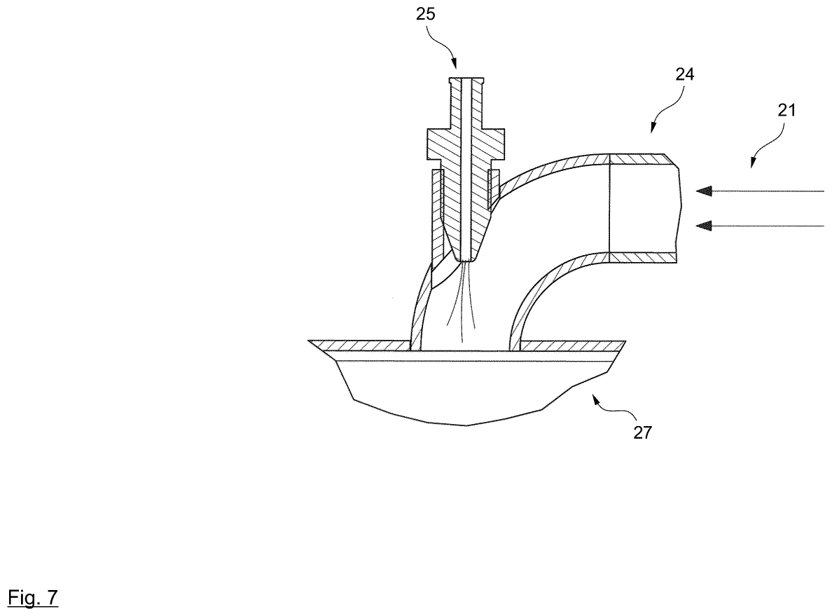

FIG. 7 shows a detail view of an embodiment of the air or water inlet of the nozzle.

The side view of an embodiment of the device according to the invention shown in FIG. 1 shows a honeycomb ceramic 2 accommodated in a container 16, which has a cleaning device 6 on its upper side, which represents the inlet side 3. On the right-hand side of the device 1 in the representation shown, the device 1 has an inlet 14 for contaminated water 19, which opens into the upper side of the container 16, so that the contaminated water reaches the upper side of the honeycomb ceramic 2 from there. The contaminated water is distributed on the surface or the inlet side 3 of the honeycomb ceramic 2 and penetrates from there through the plurality of channels 5, which are formed in the honeycomb ceramic 2. In the embodiment shown, the channels 5 run perpendicularly from the inlet side 3 to the outlet side 4 of the honeycomb ceramic 2. Finally, the water 20 filtered in the honeycomb ceramic 2 escapes from the outlet side 4 and is fed from there to a drain 15, which, in the representation shown, leads out of the device 1 at the top left next to the container 16. A cleaning device 6 for cleaning the channels 5 is arranged on the inlet side 3. This cleaning device has a nozzle 7, which is supplied with cleaning agents via a water pump 12 and with compressed air via a compressor 13 in order to flush through the channels 5. The cleaning device 6 or the nozzle 7 is linearly movable in the X direction along the inlet side 3 of the honeycomb ceramic 2, so that in each case a subset of the plurality of channels 5 can be simultaneously cleaned by the cleaning device 6 and the device 1 can continue to be operated during the cleaning. To move the cleaning device 6 along the inlet side 3, this is coupled to a drive 8, which moves the cleaning device 6 linearly along the X direction.

The perspective inner view of the container 16 shown in FIG. 2 shows, by way of example, a honeycomb ceramic 2 accommodated in the container 16, the inlet side 3 of which faces the upper side, wherein it can be seen that further honeycomb ceramics 2 would have space in the honeycomb ceramic 2. The individual ceramic block of the honeycomb ceramic 2 is fixed, as can be seen, in a frame mounted in the container 16. The frame has openings, so that the filtered water 20 can escape from the lower side or the outlet side 4 of the honeycomb ceramic 2. FIG. 2 furthermore shows an exemplary embodiment of the cleaning device 6, which has a nozzle 7 extending substantially in the Y direction, which is fixed laterally at each of its opposite ends in a rail or threaded spindle 9 and is linearly movable in the X direction along the rails or threaded spindles 9. The rails or threaded spindles 9 are in each case fixed to the container inner wall. The nozzle inlet is connected to a cleaning line 17, which is formed from a plurality of pipe elements, which are designed to be pivotable relative to one another, so that when the cleaning device 6 is moved along the X axis, the pipe connection is correspondingly also pivoted.

FIG. 3 shows a schematic cross-sectional view through the nozzle 7 and through the honeycomb ceramic 2. The nozzle 7 is arranged on the inlet side 3 of the honeycomb ceramic 2 and bears against the latter with sealing means 18 in order to prevent a laterally escaping cleaning agent between the nozzle 7 and the honeycomb ceramic 2. At the inlet side 3, the contaminated water 19, distributed over the surface thereof, impinges on the honeycomb ceramic 2 and subsequently runs through the plurality of channels 5 due to gravity in the direction of the outlet side 4 of the honeycomb ceramic 2. The channels in each case have a diameter D, which is 3 mm in the embodiment shown. When flowing through the channels 5, the contaminated water 19 passes the microorganisms 28 settled in the channels 5, which ensure a filtration of the contaminated water 19, so that finally cleaned water 20 escapes from the honeycomb ceramic 2 on the outlet side 4. Over time, more and more dirt 22 is deposited in the channels 5, which gradually block as a result. As a result, the effective usable diameter of the channels 5 is reduced. By using the cleaning device 6, it is now possible to free the channels 5 again from dirt. For this purpose, the nozzle 7 is arranged such that the water jet escaping from it is oriented parallel to the channels 5 and therefore acts in the channel direction. As a result, the channels 5 can be successively cleaned. The deposited dirt 22 escapes at the outlet side 4 in the form of solid particles and can be correspondingly filtered out there. The embodiment shown is designed such that the nozzle 7 for cleaning in each case forms a channel longitudinal row 10. It can be seen that the channel 5, on which the cleaning device 6 is arranged at the time of the illustration, has already been freed from dirt 22 and this escapes from the honeycomb ceramic 2 at the outlet side 4. Subsequently, the cleaning device 6 can be moved further in the X direction and carry out the cleaning of an adjacent channel 5.

In the plan view of the inlet side 3 of the honeycomb ceramic 2 shown in FIG. 4, it can be seen that the channels 5 are designed in a grid-like manner with a square cross section in the honeycomb ceramic 2, wherein the channels 5 in each case have the same height and width of in each case 3 mm. The honeycomb ceramic 2 thus has a plurality of longitudinal rows 10 running in the X direction and a plurality of transverse rows 11 running in the Y direction. Of course, the number of longitudinal rows 10 and of the transverse rows 11 can be correspondingly adapted depending on the configuration of the device 1. In the embodiment shown, in addition to the channels 5 themselves, the honeycomb ceramic 2 also has a square cross section, so that in each case the same number of longitudinal rows 10 and transverse rows 11 is provided. It can furthermore be seen that the nozzle 7 spans the honeycomb ceramic 2 in the Y direction and is supported in each case via parallel rails or threaded spindles 9 arranged on opposite sides of the honeycomb ceramic 2 and is movable along these in the X direction over the inlet side 3 of the honeycomb ceramic 2.

To illustrate the construction of the honeycomb ceramic 2, FIG. 5 shows a honeycomb ceramic 2 cut through substantially diagonally. This has a plurality of longitudinal rows 10 running in the X direction and a plurality of transverse rows 11 of channels 5 running in the Y direction. The channels 5 have a square cross section, wherein the edge length of the channels is to be considered as diameter D, which is 3 mm in the embodiment shown.

FIG. 6 shows a perspective view of the nozzle 7. This nozzle has on its upper side a central nozzle inlet 23 for the introduction of cleaning agent or water. From this inlet 23, a distribution bridge 24 guides the water to a plurality of further inlets, which open directly into the nozzle body 27, so that the water can be introduced into the nozzle 7 distributed over the longitudinal extent thereof. In this case, each inlet opening directly into the nozzle body 27 is furthermore assigned a compressed air inlet 25, which is set up to introduce incoming water under pressure into the nozzle body 27. On the lower side of the nozzle 7, this nozzle has a nozzle outlet 26, which extends over the entire longitudinal extent of the nozzle 7. This nozzle outlet 26 consists substantially of two metal sheets which are placed against one another and which taper the passage cross section in the direction of the outlet 26, so that the flow speed of the water in the direction of the outlet is increased for a maximum exit speed.

Finally, FIG. 7 shows a detail view of the region of the inlet of the distribution bridge 24 opening into the nozzle body 27 in cross section. In this case, the cleaning liquid 21 flows horizontally into the curved inlet and is deflected therein by 90° before it enters the nozzle body 27. In the region of the deflection, the compressed air inlet 25 opens into the inlet and is oriented perpendicularly or orthogonally to the inlet cross section of the inlet opening into the nozzle body 27. The inlet opening into the nozzle body 27 is simultaneously oriented orthogonally to the flow direction of the cleaning liquid 21 from the nozzle outlet 26, so that the compressed air inlets 25 blow the compressed air into the nozzle body 27 precisely parallel to and aligned with the nozzle outlet 26.

The features of the invention disclosed in the above description, in the figures and in the claims can be essential both individually and in any combination for the realization of the invention.

### REFERENCE SIGNS LIST

1 Device
2 Honeycomb ceramic
3 Inlet side
4 Outlet side
5 Channels
6 Cleaning device
7 Nozzle
8 Drive
9 Rail/threaded spindle
10 Longitudinal row
11 Transverse row
12 Pump
13 Compressor
14 Inlet
15 Outlet
16 Container
17 Cleaning line
18 Sealing means
19 Contaminated water
20 Filtered water
21 Cleaning liquid
22 dirt
23 Nozzle inlet
24 Distribution bridge
25 Compressed air inlet
26 Nozzle outlet
27 Nozzle body
D Channel diameter
X longitudinal direction
Y transverse direction

1. Device (1) for cleaning a honeycomb ceramic (2) for the treatment of liquid economic manures; comprising:
a honeycomb ceramic (2) for filtering contaminated water, wherein the honeycomb ceramic (2) has an inlet side (3) for introducing contaminated water and an outlet side (4) for discharging the water filtered in the honeycomb ceramic (2) and the substances separated from the contaminated water, wherein the honeycomb ceramic (2) has microorganisms for the cleavage of the contaminated water, and wherein the honeycomb ceramic (2) has a plurality of channels (5) running between the inlet side (3) and the outlet side (4);
and a cleaning device (6) arranged at the inlet side or the outlet side (3, 4) of the honeycomb ceramic (2), which is set up for cleaning the plurality of channels (5) of the honeycomb ceramic (2).

2. Device (1) according to claim 1, wherein the channels (5) running between the inlet side (3) and the outlet side (4) have a diameter (D) of in each case at least 2 mm, preferably at least 3 mm.

3. Device (1) according to claim 1, wherein the cleaning device (6) has at least one nozzle (7) directed in the direction of the honeycomb ceramic (2) for discharging a cleaning liquid, by means of which the plurality of channels (5) can be flushed through.

4. Device (1) according to claim 3, wherein the nozzle (7) has sealing means (18) for laterally sealing the nozzle (7), wherein the sealing means (18) bear against the inlet side or the outlet side (3, 4) of the honeycomb ceramic (2).

5. Device (1) according to claim 3, wherein the nozzle (7) is set up for simultaneously cleaning at least two of the plurality of channels (5).

6. Device (1) according to claim 1, wherein the cleaning device (6) has a drive (8), by means of which the nozzle (7) is movable along the inlet side or the outlet side (3, 4) of the honeycomb ceramic (2).

7. Device (1) according to claim 3, wherein the nozzle (7) is fixed laterally in at least one rail or threaded spindle (9) and is movable along the latter.

8. Device (1) according to claim 3, wherein the honeycomb ceramic (2) extends in a longitudinal and in a transverse direction (X, Y), along which the plurality of channels (5) are arranged in longitudinal and transverse rows (10, 11) in a grid-like manner, wherein the nozzle (7) extends along at least one longitudinal row (10) and is movable in the transverse direction (Y) or vice versa.

9. Device (1) according to claim 1, wherein the cleaning device (6) is set up for discharging the cleaning liquid at a pressure of 1 bar.

10. Device (1) according to claim 1, wherein the cleaning device (6) is connected to a pump (12) and a compressor (13) for conveying the cleaning liquid.

11. Method for cleaning a honeycomb ceramic (2) for processing liquid economic manures from agriculture by means of a device (1) according to claim 1, having the steps:
subjecting the inlet side (3) of the honeycomb ceramic (2) to contaminated water;
discharging the water filtered in the honeycomb ceramic (2) and the substances separated from the contaminated water from the outlet side (4) of the honeycomb ceramic (2);
cleaning the plurality of channels (5) of the honeycomb ceramic (2) by means of the cleaning device (6), wherein a cleaning liquid is discharged in the direction of the channels (5) for cleaning the channels (5) by means of the cleaning device (6).

12. Method according to claim 11, wherein the subjecting of the honeycomb ceramic (2) to contaminated water is not interrupted during the cleaning.

13. Method according to claim 11, wherein the cleaning device (6) successively cleans the plurality of channels (5), wherein the cleaning device (6) in each case simultaneously cleans at least two channels (5).

14. Method according to claim 11, wherein the cleaning device (6) is moved along the inlet side or the outlet side (3, 4) of the honeycomb ceramic (2) by means of a drive (8).

15. Method according to claim 11, wherein the cleaning liquid is an air-water mixture and is discharged at a pressure of 1 bar.
